(19) United States
(12) Patent Application Publication
(10) Pub. No.: US 2023/0241836 A1
(43) Pub. Date: Aug. 3, 2023

(54) 3D Hot-Melt Printing Process and Arrangement

(71) Applicant: Value & Intellectual Properties Management GMBH, Bruckmühl (DE)

(72) Inventors: Kai K.O. Bär, Bad Aibling (DE); Andreas Geitner, Rottach-Egern (DE)

(73) Assignee: Value & Intellectual Properties Management GMBH, Bruckmühl (DE)

(21) Appl. No.: 18/296,766

(22) Filed: Apr. 6, 2023

Related U.S. Application Data
(63) Continuation of application No. 16/756,657, filed on Apr. 16, 2020.

(30) Foreign Application Priority Data
Oct. 18, 2017 (DE) 10 2017 124 270.8
Jan. 11, 2018 (DE) 10 2018 100 508.3

(51) Int. Cl. B29C 64/153; B29C 64/264; B29C 64/194; B29C 64/118; B29C 64/295; B29C 64/30

(52) U.S. Cl. CPC B29C 64/153; B29C 64/30; B29C 64/118; B29C 64/194; B29C 64/264; B29C 64/295; B33Y 10/00

(57) ABSTRACT

A hot-melt printing process for producing a product is provided wherein the product is built up by applying polymer plies of powder or filament to a previously produced layer and by selectively locally heating predetermined points above a sintering or melting temperature and sintering or fusing the melted points with the underlying layer, wherein the respective newly applied polymer ply and optionally at least one underlying layer is preheated to a temperature with a predetermined difference to the sintering or melting temperature by flat or migrating irradiation of short-wave or medium-wave IR radiation, and wherein the preheating of at least the newly applied polymer ply and/or the local heating above the sintering or melting temperature is carried out by means of near IR radiation, in particular with a radiation density maximum in the wavelength range between 0.77 and 1.2 µm and with high power density above 200 KW/m².

### CROSS REFERENCE TO RELATED DOCUMENTS

The instant application is a continuation of pending application 16/756,657 filed Apr. 16, 2020 and claims priority to that application. All disclosure of the parent application is incorporated at least by reference.

### BACKGROUND OF THE INVENTION

### 1. Field of the Invention

The present invention is in the technical field of

### 2. Description of Related Art

In recent years, a large number of processes have been developed for the layered construction of three-dimensional products, which are summarized under the terms “additive manufacturing” or “3D printing”. These processes are partly based on melting and solidification steps and then include selective local heating of previously applied layers of material, which is also referred to here as “point-by-point” or “point-scanning” heating. For this purpose, a processing laser that can be moved over the material layers under coordinate control is usually used, but other irradiation units are also possible. In the case of special process control, an inkjet printer is used to apply an agent that increases the absorption coefficient of the last layer of material applied, and then the material is irradiated with radiation of such a wavelength that heating above the melting temperature of the material is achieved by using the absorption-increasing effect. In the interest of a fast sequence of the sequential local melting of the material layers, especially powder layers, and thus a high productivity of the process, the worktable or the already manufactured partial product is preheated to a temperature close to the melting temperature by means of conventional heating techniques. For example, the entire process can be carried out in a heated chamber, or conventional radiant heaters emitting medium-wave or long-wave infrared radiation are provided on the worktable.

The heating methods known to be used for preheating essentially produce volume heating and have certain disadvantages as a result. These include the principle-related delay in the re-solidification of the sequentially melted material areas, which has a negative effect on the productivity of the process, and the occurrence of potentially quality-reducing unevenness of the (partial) product surface. In addition, the energy consumption is relatively high.

What is clearly needed is a 3D hot-melt printing process for producing a three-dimensional product essentially from a polymer powder or polymer filaments, wherein the product is built up layer-by-layer by applying polymer plies to a respectively previously produced layer and by selective local heating of predetermined points of the layer above a sintering or melting temperature of the powder and fusing of the melted points with the underlying layer, and wherein preheating of the existing partial product to a temperature close to the sintering or melting temperature is effected by an additional heating device. A method for carrying out such a process is needed as well.

### BRIEF SUMMARY OF THE INVENTION

A 3D hot-melt printing process for producing a three-dimensional product essentially from a polymer powder or polymer filaments is provided, wherein the product is built up layer-by-layer by applying polymer plies of powder or filament to a respective previously produced layer and by selective local heating predetermined points of the layer above a sintering or melting temperature of the powder or filaments and sintering or fusing the melted points with the underlying layer, the respective newly applied polymer ply and optionally at least one underlying layer is preheated to a temperature with a predetermined difference to the sintering or melting temperature by flat or migrating irradiation of short-wave or medium-wave IR radiation, and the preheating of at least the newly applied polymer ply and/or the local heating above the sintering or melting temperature is carried out by means of near IR radiation, in particular with a radiation density maximum in the wavelength range between 0.77 and 1.2 µm and with high power density above 200 KW/m². melting device module.

### BRIEF DESCRIPTION OF THE SEVERAL VIEWS OF THE DRAWINGS

FIG. 1 shows a schematic representation, in the manner of a longitudinal section, of an arrangement and a process according to an embodiment of the invention,

FIG. 2 shows a schematic representation, in the manner of a longitudinal section, of an arrangement and a process according to a further embodiment of the invention, and

FIG. 3 shows a schematic representation, in the manner of a longitudinal section, of an arrangement and a process according to a further embodiment of the invention.

### DETAILED DESCRIPTION OF THE INVENTION

In one embodiment the invention is based on the object of providing an improved process of the generic type and an arrangement for carrying it out, with which high productivity can be achieved while at the same time meeting high quality requirements and moderate energy consumption. This object is solved in its process aspect by a 3D hot-melt printing process with the features of claim 1 and in its device aspect by an arrangement with the features of claim 11. Appropriate further developments of the inventive idea are the subject matter of the dependent claims.

One idea of the present invention is to concentrate the necessary preheating prior to the local, “point-by-point” melting of newly applied layers of material on the areas of the resulting product that are actually to be processed. Another idea of the invention is to achieve this by using radiation with a relatively small penetration depth, namely near IR radiation (also known as NIR radiation), in particular with a radiation density maximum in the wavelength range between 0.77 and 1.2 µm. Finally, the invention includes the idea of using this selectively acting radiation with relatively high power density, in particular above 200 kW/m2.

In a practically significant embodiment, a thermoplastic polymer powder is used as the polymer powder. In principle, however, the process can also be carried out with other meltable polymers, in powder or filament form or also as granulate.

In particular, a temperature difference of 20 K or more, especially 25 K or more, to the sintering or melting temperature is realized in an advantageous way when using near IR radiation to preheat the polymer ply. Depending on the specific manner of process control, the preheating can also be limited to even significantly lower preheating temperatures.

The invention thus provides, at least in certain embodiments, several considerable advantages over prior art methods.

In particular, the heating of essentially only the last starting material layer immediately before local sintering or melting allows the avoidance of large workpiece volumes and is therefore basically energy-saving and reduces the thermal load on the entire device. Furthermore, the procedure according to the invention reduces the permanent effect of relatively high temperatures on areas of starting material layers processed in earlier process steps that are not sintered or fused according to the program and thus unintentional softening and deterioration of the non-sintered powder in those layers, which can significantly improve the efficiency of recovering recyclable metal powder after the completion of a product.

Since, according to the invention, larger temperature differences can be set between the “points” of the powder or filament layers to be melted and those not to be melted, such undesirable softening effects are significantly reduced, if not completely eliminated. If conventional methods often require the finished product to be cleaned with much effort of such adhering softening areas, such cleaning steps can be largely dispensed with when applying the invention. In addition, screening or other treatment of the starting material returned from the process can be largely dispensed with.

A further, relatively independent idea of the invention is to use NIR radiation for local heating of the preheated material layer above the sintering or melting temperature, especially in conducting processes in which the required local selectivity of the melting has been ensured by selective pre-coloring or pre-doping. Especially for local heating above the sintering or melting temperature, near IR-radiation with a radiation density maximum between 0.77 and 1.0 µm can be used.

In an expedient combination of the two relatively independent basic ideas of the invention, it is provided that the preheating of the newly applied polymer ply on the one hand and the local heating above the sintering or melting temperature, i.e. the actual sintering or melting step, on the other hand, are each carried out with near IR radiation with individually adjusted radiation density maximum and/or individually adjusted power density.

In one embodiment, the near IR radiation is irradiated sequentially in sections into partial sections of the total area of the respective polymer ply, wherein the selective local heating above the sintering or melting temperature is carried out for predetermined points within a preheated partial section. The preheating thus “runs” over the surface of the respective material layer to be treated in a preparatory and accompanying manner with the local heating above the sintering or melting temperature.

In appropriate embodiments of the process, the power density of the near IR radiation irradiated over a surface is in the range between 500 kW/m² and 2 MW/m², and the radiation of at least one halogen radiator, in particular a plurality of halogen radiators, with a radiator temperature of more than 2700 K, in particular up to 3100 K, is used as near IR radiation.

Similar to conventional methods, a further embodiment of the process involves selective local heating of predetermined points by scanning the polymer ply with a laser beam. In principle, however, a scanning point-by-point heating of the material layer to be processed can also be effected by other focused radiation, for example by means of laser diodes.

In a further embodiment, selective local heating is achieved by applying an agent increasing the absorption coefficient to the polymer ply at specific points and then irradiating near IR radiation or light radiation in the long-wave visible range. With this principle, “pointwise” heating above the sintering or melting temperature is therefore not, or in any case not exclusively, effected by a highly focused radiation sequentially scanning the material layer pointwise, but is ensured by the selective increase of the absorption coefficient of the material layer. The absorption-increasing agent is in particular a strongly pigmented liquid, which can also be described as ink.

In this case, the near IR radiation can be used especially as radiation for selective local heating of the doped points/areas, and the agent increasing the absorption coefficient is selected to match the near IR radiation. This is to be understood in such a way that an agent with a high absorption capacity, especially in the wavelength range between 0.77 and 1.2 µm, is selectively applied to the material layer.

3D hot-melt printing processes using black inks are known per se. In the context of the present invention, the use of NIR radiation for local (“pointwise”) heating of the areas marked with the ink also makes it possible to use colored, i.e. non-black, inks. The special properties of NIR radiation also provide sufficient selectivity of the heating towards unmarked areas for inks colored with pigments or dyes.

This in turn offers the designer much greater freedom in the color design of the product, because there are no longer necessarily layers of black ink between the individual layers of material. This makes it possible, on the one hand, to produce single-colored products in brilliant colors using the process according to the invention, but on the other hand, it is also possible to create specifically multi-colored products by applying inks with different colors in different layers or even within one layer.

The use of NIR radiation to heat areas marked with an absorption-increasing agent also allows the use of conductive inks, i.e. inks filled to a considerable extent with metal powder. When these inks are irradiated, a metallic area (in practical terms, especially as a metallic track) remains on the surface of the plastic layer after evaporation of the solvent. This allows the production of multilayer conductor structures in the form of multilayer printed circuit boards or, in any case, structured conductor layers embedded in a plastic body.

For the person skilled in the art, advantageous embodiments of the proposed arrangement are mainly the result of the process aspects as explained above, so that detailed explanations are largely avoided. However, attention is drawn to the following aspects of the device:

While the design of the overall arrangement largely corresponds to that of known 3D printers, whose function is based on the sequential local melting of plastic powders or filaments applied in layers, a special feature is the design of the preheating device and/or the actual melting device. This comprises an NIR irradiation device for irradiating near IR radiation, in particular with a radiation density maximum in the wavelength range between 0.77 and 1.2 µm, with a high power density above 200 kW/m² onto a predetermined area in the region of the worktable. The expression “in the region of the worktable” is to be understood in a general sense and does not necessarily mean that the NIR irradiation device is placed vertically above the worktable, nor does it necessarily mean that its lateral extension coincides with that of the worktable. If the reflector geometry is suitable, the NIR irradiation device can have a smaller base area than the worktable and can also be positioned diagonally above it or even to the side.

In a practically proven embodiment, the NIR irradiation device comprises at least one linear halogen radiator, in particular a plurality of halogen radiators, with an associated reflector such that the radiation of the or each infrared radiator is concentrated in the direction of the worktable. In other embodiments, however, the IR irradiation device may also comprise an array of high-power NIR laser diodes, and in such a configuration, special reflectors are largely unnecessary.

In a further embodiment, the majority of halogen radiators with associated reflector are mounted stationary (optionally in a height-adjustable manner) above the worktable. However, it is preferable in contrast thereto that the plurality of halogen radiators with associated reflector is mounted above the worktable so that it can be moved in a position-controlled manner in at least one axial direction of an XY plane. This latter design serves to implement a process control in which the preheating is only carried out for one specific partial surface section of the product being processed at a time and this section “moves” over the surface to be processed.

In a manner known per se, the means for effecting selective local heating of predetermined points of a pre-applied polymer ply (hereinafter referred to as “melting device”) may comprise a laser with a downstream scanner for the pointwise application of near infrared radiation or visible light in the long wavelength range to the predetermined points.

As an alternative or in combination with the above-mentioned design, the melting unit can be equipped with a coordinate-controlled inkjet printer for pointwise application of an absorption-increasing agent to the specified points. As already mentioned above, the radiation causing a punctiform melting can then be generated by an irradiation unit whose radiation is not focused on individual points of the surface to be processed, for example by the NIR irradiation unit itself which is used for preheating. For example, part of the radiation from this NIR irradiation unit can be decoupled and directed onto the preheated sections with a slight time delay when the surface of the workpiece is covered, or an additional NIR irradiation unit is provided for heating above the sintering or melting temperature.

In the above-mentioned process design with colored inks, inkjet printers known per se with several tanks for holding inks with different colors can be used in order to apply multi-colored “images” (certainly within the scope of the usual control of such printers) to the surface of a previously applied layer of starting material, whereby colored structured plastic products can be built up step by step.

In a process design using conductive inks, which was also mentioned above, the inkjet printer used is adapted in such a way that it works with conductive liquids without any problems.

In a practical constructional embodiment according to this aspect, the inkjet printer and one NIR irradiation device upstream and one NIR irradiation device downstream in its travel direction above the worktable can be combined to form a melting device module which can be moved in an axial direction of an XY plane above the worktable. The selective local heating of predetermined points can be achieved even more specifically by the point-by-point application of an agent increasing the absorption coefficient to the polymer ply and subsequent irradiation of near IR radiation.

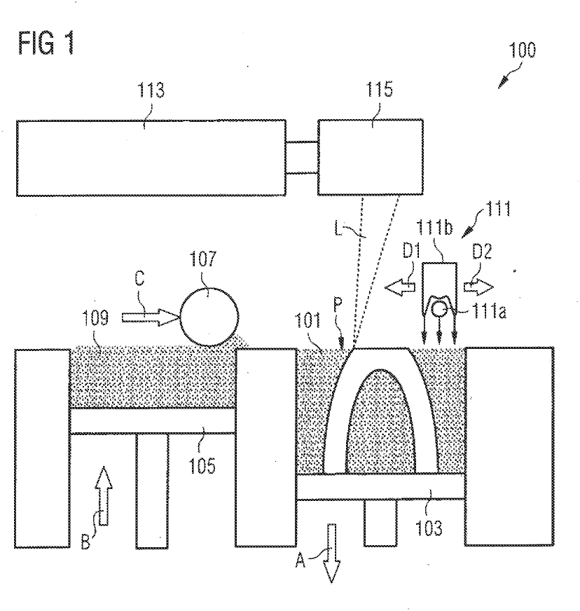

FIG. 1 shows by way of a sketch-like illustration an arrangement 100 for the additive production of a (here still incompletely shown) three-dimensional plastic product P, which is formed from a plastic powder bed 101 by means of layer-by-layer application of plastic powder and scanning local heating of the individual layers.

The arrangement comprises a worktable 103 on which the plastic powder bed 101 is applied layer-by-layer and product P is formed. As symbolized by the arrow A, the worktable 103 can be moved vertically in order to keep the surface of the plastic powder bed 101 at the same height level despite the fact that the height increases with the layer application. A powder application device for feeding plastic powder into the actual working area comprises a ram 105, which is vertically movable in the direction of the arrow B, i.e. in the opposite direction to the arrow A, and a powder application roller 107, which is movable in the direction of the arrow C and moves plastic powder 109 received as a supply on the ram 105 in individual layers of predetermined thickness into the working area (i.e. in the figure to the right into the powder bed 101).

An NIR irradiation unit 111, which in the example is formed by a single halogen lamp 111a and an associated reflector 111b, is positioned above the working area. The NIR irradiation unit 111, as symbolized by the arrows D1 and D2, can be moved laterally back and forth across the powder bed 101 and serves to preheat the respective irradiated sections of the powder bed to a temperature of approx. 25-30 K below a sintering or melting temperature of the plastic powder. The NIR irradiation unit 111 can also include several halogen lamps with a reflector that is then shaped accordingly.

A commercial processing laser 113, selected with regard to the absorption properties of the plastic powder to be processed and obviously under cost aspects, with a downstream scanner 115 is arranged above the working area. The laser 113 and scanner 115 are designed in such a way that the surface of the powder bed 101 can be scanned with a laser beam L in order to heat the powder bed 101, which is preheated by the NIR radiation on its surface, above the sintering or melting temperature at the points of impact predetermined according to the product geometry. This causes a sintering with the respective underlying layer at those points, thus forming the next layer of product P. In the usual way, the plastic powder 109 remains in the powder state at those points where it has not been heated above the sintering or melting temperature and, after removal from the worktable, falls off product P or can be washed out of it.

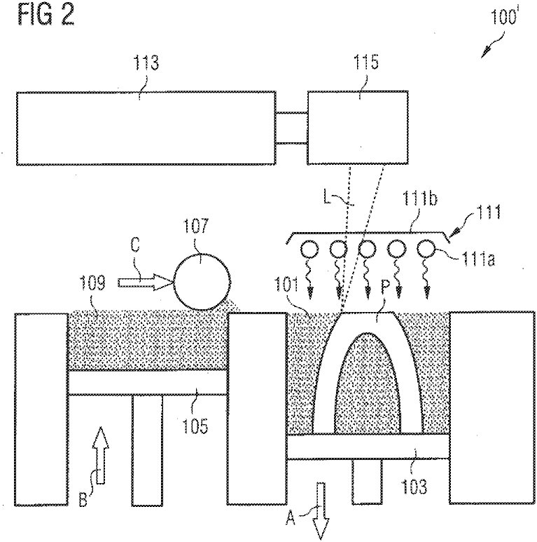

FIG. 2 shows an arrangement 100′ which is very similar to arrangement 100 according to FIG. 1, in which the matching parts are marked with the same reference numbers as in FIG. 1 and are not explained again here. The essential difference to arrangement 100 is that instead of a laterally movable NIR irradiation device, here a stationary NIR irradiation device 111′ with a simple large-area reflector 111b and a row of halogen lamps 111a arranged below it is provided. It is understood that the relative arrangement of laser 113 and scanner 115 on the one hand and the NIR irradiation device 111 on the other hand must be determined in such a way that the radiation from both irradiation units can reach the entire surface of the powder bed 101 to be processed in an unhindered manner.

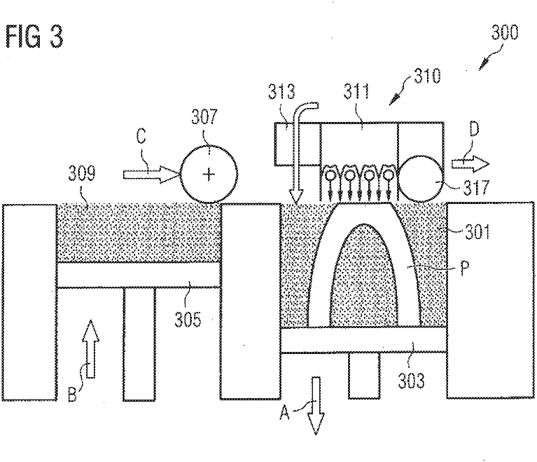

FIG. 3 also shows an arrangement 300 partially similar to the arrangement according to FIG. 1; however, there are more significant deviations here than in arrangement 100′ according to FIG. 2. While the constructive design of the working area and powder feed corresponds to that according to FIGS. 1 and 2, the provision of the radiation required for thermal processing of the plastic powder is solved differently.

For this purpose, a combination processing module 310 is provided, which, in addition to an NIR preheating device 311 (with a plurality of here not individually designated halogen lamps and reflector sections), comprises a further NIR irradiation unit 313 and a printing roller 317. The combination processing module 10 is moved in the direction of the arrow D over the powder bed 301 on the worktable 303, wherein first the respective uppermost layer of the plastic powder is provided with a pattern of an absorption-increasing agent, then preheated and finally heated to a temperature above the sintering or melting temperature by means of the further NIR irradiation unit 313 only in the printed areas.

The final radiation input into the surface of the powder bed 301 is flat here, i.e. not pointwise, and only causes the material-specific sintering or melting temperature to be exceeded pointwise where an absorption-increasing agent has been selectively applied to the points or areas of the uppermost powder layer to be sintered or melted in an upstream further process step. In the example shown, this application is carried out with a printing roller, but in practice it is advisable to use an inkjet printer guided over the surface of the powder bed in front of the combination processing module.

The NIR preheating unit 311 and the other NIR irradiation unit 313 can basically be constructed in the same way, and this offers particular advantages when the combination processing module 310 (in a modified arrangement with regard to the powder application to the workpiece in progress) performs reciprocating work cycles. In this case, the two NIR irradiation devices alternately act as preheating and melting devices and must be configured variably accordingly. The adjustment of specific radiation parameters (position of the radiation density maximum, power density, if necessary, focusing range...) is then carried out in each case on a single step basis by varying the control of the halogen emitters and, if necessary, by varying the reflector geometry. Furthermore, embodiments of the invention are also possible in a number of variations of the examples shown here and aspects of the invention highlighted above.

It will be apparent to the skilled person that the embodiments illustrated and described are exemplary only, and equivalents may be implemented. The scope is only limited by the claims.

1. 3D hot-melt printing process for producing a three-dimensional product essentially from a polymer powder or polymer filaments,
wherein the product is built up layer-by-layer by applying polymer plies of powder or filament to a respective previously produced layer and by selective local heating predetermined points of the layer above a sintering or melting temperature of the powder or filaments and sintering or fusing the melted points with the underlying layer,
wherein the respective newly applied polymer ply and optionally at least one underlying layer is preheated to a temperature with a predetermined difference to the sintering or melting temperature by flat or migrating irradiation of short-wave or medium-wave IR radiation, wherein
the preheating of at least the newly applied polymer ply and/or the local heating above the sintering or melting temperature is carried out by means of near IR radiation, in particular with a radiation density maximum in the wavelength range between 0.77 and 1.2 µm and with high power density above 200 KW/m².

2. 3D hot-melt printing process according to claim 1, wherein for local heating above the sintering or melting temperature near IR radiation with a radiation density maximum between 0.77 and 1.0 µm is used.

3. 3D hot-melt printing process according to claim 1, wherein a temperature difference of 20 K or more, in particular of 25 K or more, to the sintering or melting temperature is realized when using near IR radiation for preheating the polymer ply.

4. 3D hot-melt printing process according to claim 1, wherein the near IR radiation is sequentially irradiated in sections into partial sections of the total area of the respective polymer ply, wherein the selective local heating above the sintering or melting temperature is carried out in each case for predetermined points within a preheated partial section.

5. 3D hot-melt printing process according to one of the preceding claim 1, wherein the power density of the irradiated near IR radiation is in the range between 500 kW/m² and 2 MW/m².

6. 3D hot-melt printing process according to claim 1, wherein radiation of at least one linear halogen radiator, in particular a plurality of halogen radiators, with a radiator temperature of more than 2700 K, in particular up to 3100 K, is used as near IR radiation.

7. 3D hot-melt printing method according to claim 1, wherein selective local heating of predetermined points is affected by scanning the polymer ply with a laser beam.

8. 3D hot-melt printing process according to one claim 1, wherein selective local heating of predetermined points is affected by pointwise application of an agent increasing an absorption coefficient, especially in ink form, to the polymer ply and subsequent irradiation with near IR radiation.

9. 3D hot-melt printing process according to claim 8, wherein the agent increasing the absorption coefficient is selected to be adapted to the near IR radiation.

10. 3D hot-melt printing process according to claim 9, wherein the agent increasing the absorption coefficient is colored.

11. 3D hot-melt printing process according to claim 10, wherein in the course of the construction of the three-dimensional product of polymer plies, various agents increasing the absorption coefficient with different colors are used, or agents with different colors are used in areas within individual layers or for different layers in their entirety.

12. 3D hot-melt printing process according to claim 8, wherein the agent increasing the absorption coefficient has a metallic filling, such that metallically conductive areas, in particular conductive tracks, are incorporated during the application of at least some polymer plies.

13. 3D hot-melt printing process according to claim 8, wherein the preheating of the newly applied polymer ply on the one hand and the local heating above the sintering or melting temperature on the other hand are each carried out with near IR radiation with individually set radiation density maximum and/or individually set power density.

14. A 3D hot-melt printing system for producing a three-dimensional product essentially from a polymer powder or polymer filaments, comprising:
a worktable as a base for the layered construction of the three-dimensional product,
a powder application device for sequentially applying polymer plies of a polymer powder or polymer filaments in the area of the worktable,
a preheating device for preheating each new polymer ply, the preheating device comprising an IR irradiation device for irradiating IR radiation onto a predetermined area in the region of the worktable, and
a melting device for affecting selective local heating of predetermined points of the new polymer ply above a sintering or melting temperature of the polymer powder,
wherein the preheating device and/or the melting device has an NIR irradiation device for generating and irradiating near IR radiation, in particular with a radiation density maximum in the wavelength range between 0.77 and 1.2 µm, with high power density, in particular above 200 kW/m₂, onto the uppermost polymer ply.

15. 3D hot-melt printing system according to claim 14, wherein the melting device comprises a laser with a downstream scanner for pointwise irradiation of near NIR radiation or visible light in the long-wave range onto the predetermined points.

16. 3D hot-melt printing system according to claim 14, wherein an inkjet printer, which can be moved under coordinate control, is connected upstream of the melting device for pointwise application of an absorption-increasing agent to the predetermined points.

17. 3D hot-melt printing system according to claim 16, wherein the inkjet printer comprises a plurality of ink tanks for holding inks having different colors and is adapted for program-controlled selection of one of the ink tanks for selective application of one of the inks.

18. 3D hot-melt printing system according to claim 16, wherein the melting device is designed as an NIR irradiation device for irradiating near IR radiation with a maximum radiation density of between 0.77 and 1.0 µm and is arranged in such a way that it is arranged downstream of the inkjet printer in the process sequence.

19. 3D hot-melt printing system according to claim 14, wherein the NIR irradiation device comprises at least one linear halogen radiator, in particular a plurality of halogen radiators, with an associated reflector such that the radiation of the or each infrared radiator is concentrated in the direction of the uppermost polymer ply.

20. 3D hot-melt printing system according to claim 19, wherein the plurality of halogen radiators with associated reflector are mounted above the worktable so as to be movable in position-controlled manner in at least one axial direction of an XY plane. 3D hot-melt printing system.

21. 3D hot-melt printing system according to claim 6, wherein the inkjet printer and a respective NIR irradiation device connected upstream and downstream in the direction of travel thereof above the worktable are combined to form a melting device module which is movable in an axial direction of an XY plane above the worktable.

22. 3D hot-melt printing system according to claim 21, wherein the NIR irradiation devices upstream and downstream of the inkjet printer are constructed in essentially the same way, but can be controlled in a differentiated manner with respect to the maximum radiation density and/or the power density as a function of the movement device of the melting device module.
